(19) United States
(12) Patent Application Publication
(10) Pub. No.: US 2018/0247183 A1
(43) Pub. Date: Aug. 30, 2018

(54) METHOD AND SYSTEM FOR GENERATIVE MODEL LEARNING, AND RECORDING MEDIUM

(71) Applicant: Yusuke Kanebako, Miyagi (JP)

(72) Inventor: Yusuke Kanebako, Miyagi (JP)

(73) Assignee: Ricoh Company, Ltd., Tokyo (JP)

(21) Appl. No.: 15/886,311

(22) Filed: Feb. 1, 2018

(30) Foreign Application Priority Data
Feb. 24, 2017 (JP) 2017-033845

(51) Int. Cl. G06N 3/04; G06N 3/08; G06N 5/04

(52) U.S. Cl. CPC G06N 3/0454; G06N 5/046; G06N 3/088

(57) ABSTRACT

A system and a method for learning generative model includes: first learning a generative model for generating data based on first learning data; and second learning the generative model being learned in the step of first learning based on second learning data, and the step of first learning and the step of second learning are repeated.

### CROSS-REFERENCE TO RELATED APPLICATIONS

This patent application is based on and claims priority pursuant to 35 U.S.C. § 119(a) to Japanese Patent Application No. 2017-033845, filed on Feb. 24, 2017, in the Japan Patent Office, the entire disclosure of which is hereby incorporated by reference herein.

### BACKGROUND

### Technical Field

The present invention relates to a generative model learning method, a generative model learning system, and a recording medium.

### Description of the Related Art

Conventionally, a generative model is used in the field of artificial intelligence. In the generative model, a model of dataset is learned such that data similar to learning data included in this dataset can be generated.

In recent years, generative models using deep learning, such as a variational auto encoder (VAE) and generative adversarial networks (GANs), have been proposed. These generative models are called deep generative models and are capable of generating data similar to learning data with higher accuracy than the conventional generative models.

In a conventional deep generative model, however, it has been difficult to control data to be generated and thus, it has been difficult to finally generate intended data.

### SUMMARY

Example embodiments of the present invention include a system and a method for learning generative model, which includes: first learning a generative model for generating data based on first learning data; and second learning the generative model being learned in the step of first learning based on second learning data, and the step of first learning and the step of second learning are repeated.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a hardware configuration of a generative model learning device, according to an embodiment;

FIG. 2 is a diagram illustrating a functional configuration of the generative model learning device, according to the embodiment;

FIG. 3 is a diagram schematically illustrating a learning procedure by a first learner of the generative model learning device, according to the embodiment;

FIG. 4 is a flowchart illustrating operation performed by the learner, according to the embodiment;

FIG. 5 is a diagram schematically illustrating a learning procedure by a second learner of the generative model learning device, according to the embodiment;

FIG. 6 is a flowchart illustrating operation performed by the learner, according to the embodiment;

FIG. 7 is a diagram illustrating an example of images used for learning;

FIG. 8 is a diagram illustrating an example of images used for learning;

FIG. 9 is a diagram illustrating an example of images generated using a conventionally known deep convolutional generative adversarial networks (DCGANs); and

FIG. 10 is a diagram illustrating an example of images generated by the generative model learning device, according to the embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments of a system and a method for learning generative model, and a generative model learning program according to the present invention will be described in detail with reference to the accompanying drawings.

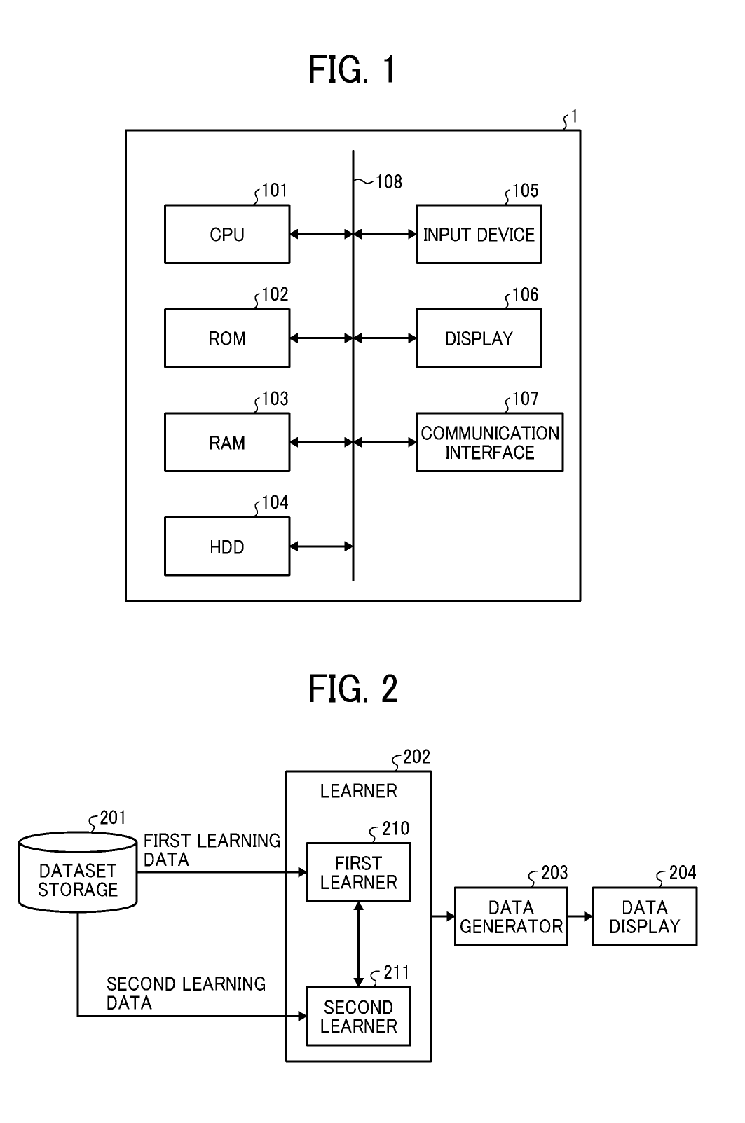

FIG. 1 is a diagram illustrating a hardware configuration of a generative model learning device 1, as one example of a generative model learning system, according to the present embodiment. The generative model learning device 1 is implemented by a computer such as a server computer and a client computer. As illustrated in FIG. 1, the generative model learning device 1 includes a central processing unit (CPU) 101, a read only memory (ROM) 102, a random access memory (RAM) 103, and a hard disk drive (HDD) 104. The generative model learning device 1 also includes an input device 105, a display 106, a communication interface 107, and a bus 108.

The CPU 101 executes a program to control each component of the generative model learning device 1 and thus implements various functions of the generative model learning device 1. Various functions of the generative model learning device 1 will be described later. The ROM 102 stores various types of data including a program executed by the CPU 101. The RAM 103 is a volatile memory that operates as a work area for the CPU 101. The HDD 104 stores various types of data including a program executed by the CPU 101 and a dataset. The input device 105 inputs information in accordance with operation by a user to the learning device 1. The input device 105 may be a mouse, a keyboard, a touch panel, or a hardware key. The display 106 displays various types of data including generative data to be described later. The display 106 may be a liquid crystal display, an organic electro luminescence (EL) display, or a cathode ray tube display. The communication interface 107 is an interface for connecting the learning device 1 to a network such as a local area network (LAN) or the Internet. The communication interface 107 may be implemented by a network interface circuit, for example. The generative model learning device 1 communicates with an external device via the communication interface 107. The bus 108 is a wire for coupling the CPU 101, the ROM 102, the RAM 103, the HDD 104, the input device 105, the display 106, and the communication interface 107 with each other. In the example in FIG. 1, the generative model learning device 1 is implemented by a single computer but is not limited to this example. For example, a configuration of the generative model learning device 1 including a plurality of computers connected via a network may be adopted.

FIG. 2 is a diagram illustrating a functional configuration of the generative model learning device 1 according to this embodiment. As illustrated in FIG. 2, the generative model learning device 1 includes a dataset storage 201, a learner 202, a data generator 203, and a data display 204.

The dataset storage 201 stores a dataset prepared in advance by the user. The dataset is a combination of a plurality of pieces of learning data and is utilized in learning a generative model for generating data. The learning data may be image data, text data, or video data. Hereinafter, it is assumed that the learning data is image data. In this embodiment, the dataset storage 201 stores two types of datasets (combinations of the plurality of pieces of learning data). More specifically, the dataset storage 201 stores a first learning dataset that is a combination of a plurality of pieces of first learning data and a second learning dataset that is a combination of a plurality of pieces of second learning data. The dataset storage 201 may be implemented by any desired memory such as the ROM 102 or RAM 103, which operates under control of the CPU 101.

The learner 202 learns the generative model for generating data based on the first learning data and the second learning data prepared in advance. In this embodiment, the learner 202 is adapted to learn the generative model based on the first learning dataset and the second learning dataset. The learner 202 may be implemented by instructions of the CPU 101.

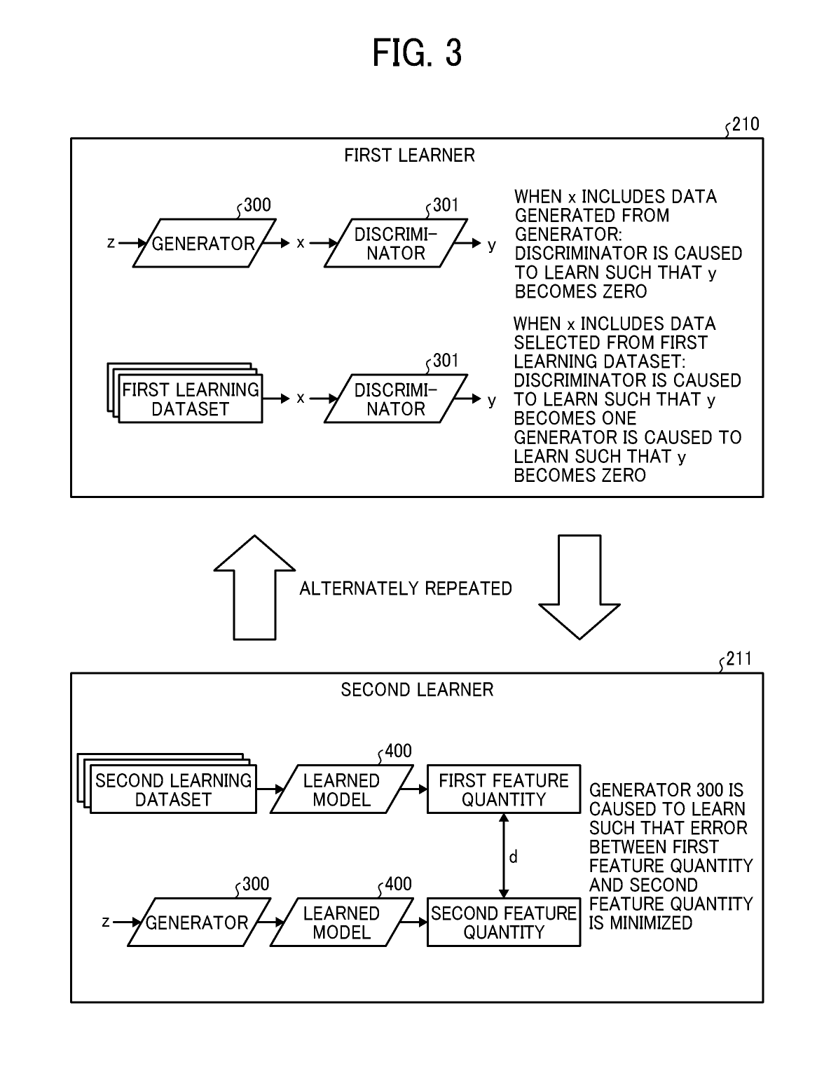

As illustrated in FIG. 2, the learner 202 includes a first learner 210 and a second learner 211. The first learner 210 learns the generative model for generating data based on the first learning data. In this embodiment, the generative model includes at least a generator that generates data. The first learner 210 learns the generative model according to a learning method by an adversarial network including a generator (corresponding to a generator 300 illustrated in FIG. 3 to be described later) and a discriminator that discriminates the first learning data from data generated by the generator (corresponding to a discriminator 301 in FIG. 3 to be described later). More specifically, the first learner 210 learns the generative model based on the evaluation value of the generator and the evaluation value of the discriminator. The evaluation value of the discriminator indicates a higher value as the discrimination accuracy of the discriminator is higher and the evaluation value of the generator indicates a higher value as the discriminator erroneously recognizes data generated by the generator as being the first learning data more frequently. The specific content of learning by the first learner 210 will be described later. The first learner 210 is adapted to learn values of respective parameters constituting each of the generator and the discriminator (learns the generative model) based on the first learning dataset.

The second learner 211 learns the generative model being learned by the first learner 210 based on the second learning data. The following description will be made on the premise that the “generative model” represents the generative model being learned by the first learner 210. In this example, the second learner 211 calculates a first feature quantity from the second learning data using a learned model used for calculating the feature quantity from input data. The second learner 211 also calculates a second feature quantity from data generated according to the generative model (the generative model being learned by the first learner 210), using the learned model. The second learner 211 then learns the generative model such that an error between the first feature quantity and the second feature quantity is minimized. The learned model here is a model already learned by deep learning. In this example, the deep learning refers to learning using a convolutional neural network (CNN) but is not limited to this example. In addition, for example, a configuration may be adopted in which the second learner 211 extracts the second feature quantity from the second learning data with another feature quantity extraction method without using the learned model. For example, in the case of image data, a known extraction method for histogram of oriented gradients (HOG) feature quantity or a known extraction method for scale-invariant feature transform (SIFT) feature quantity may be used. In the case of sound data, for example, a known extraction method for formant transition feature quantity can be used.

In this example, the second learner 211 calculates a first error indicating an error between a style matrix calculated from the second learning data using the learned model (a model already learned by learning using the CNN) and a style matrix calculated from data generated according to the generative model (generative data), using the same learned model. The second learner 211 also calculates a second error indicating an error between an intermediate layer output calculated from the second learning data using the above learned model and an intermediate layer output calculated from the generative data using the same learned model. The second learner 211 then learns the generative model such that the sum of the first error and the second error is minimized. That is, in this example, the first feature quantity includes the style matrix calculated from the second learning data using a model already learned by learning using the CNN, and the intermediate layer output calculated from the second learning data using the same learned model. Meanwhile, the second feature quantity includes the style matrix calculated from the generative data using the above learned model, and the intermediate layer output calculated from the generative data using the same learned model. The specific content of learning by the second learner 211 will be described later. The second learner 211 is adapted to learn values of respective parameters constituting the generator included in the generative model (learns the generative model) based on the second learning dataset. While the second learner 211 learns the generative model so as to minimize the sum of the first error and the second error in this example, in other example, the second learner 211 may learn the generative model so as to make the sum of the first error and the second error smaller than, for example, a threshold, or to be in a certain range.

The learner 202 alternately repeats learning by the first learner 210 (first learning step) and learning by the second learner 202 (second learning step) to learn the generative model.

The data generator 203 inputs an input variable (latent variable) to the generative model learned by the learner 202 to generate data. In this example, the data generated by the data generator 203 is referred to as “generative data”. The data generator 203 may be implemented by instructions of the CPU 101.

The data display 204 displays the generative data generated by the data generator 203 on the display 106. The data display 204 may be implemented by the instructions of the CPU 101, which operates in cooperation with the display 106.

Next, the specific content of learning by the learner 202 will be described according to the embodiment. FIG. 3 is a diagram schematically illustrating a learning procedure by the learner 202.

First, learning by the first learner 210 will be described. In this example, the first learner 210 uses generative adversarial networks (GANs) as an example of the learning method by the adversarial network but the example is not limited to this one. In FIG. 3, x represents an input variable input to the discriminator 301, y represents an output variable output from the discriminator 301, and z represents an input variable (latent variable) input to the generator 300.

The discriminator 301 is caused to learn so as to be able to discriminate whether the input variable x includes the first learning data or the data generated by the generator 300 (generative data). In this example, when the input variable x includes the generative data, the output variable becomes zero. When the input variable x includes the first learning data, values of respective parameters constituting the discriminator 301 are learned such that the output variable y becomes one. On the other hand, the generator 300 is caused to learn so as to be able to generate the generative data that the discriminator 301 is not able to discriminate from the first learning data. In this example, when the input variable x includes the first learning data, values of respective parameters constituting the generator 300 are learned such that the output variable y becomes zero. The learning described above is repeated, whereby the discrimination accuracy of the discriminator 301 is improved and the generation accuracy of the generator 300 (the accuracy with which the generative data is similar to the first learning data) is improved.

The above learning by the first learner 210 is implemented by solving the evaluation function expressed by the following expression (1).

$${min}_{G} {max}_{D} V ( D , G ) = {E}_{x ∼ pdata ( x )} [ log D ( x ) ] + {E}_{z ∼ pz ( z )} [ log ( 1 - D ( G ( z ) ) ) ] \qquad [ Mathematical Expression 1 ]$$

In the above expression (1), V corresponds to an evaluation value, D corresponds to a parameter group constituting the discriminator 301, G corresponds to a parameter group constituting the generator 300, E[⋅] corresponds to an expectation value, and x˜pdata corresponds to the collection of the learning data (input variable x) sampled from the dataset. In addition, z˜pz corresponds to the input variable z, D(x) corresponds to the output variable y when the input variable x is input, and G(z) corresponds to the generative data when the input variable z is input.

The first term on the right side of the above expression (1) corresponds to the evaluation value of the discriminator 301 and has a higher value as the discrimination accuracy of the discriminator 301 is higher. The second term on the right side of the above expression (1) corresponds to the evaluation value of the generator 300 and has a high value as the discriminator 301 erroneously recognizes the generative data as the first learning data more frequently (there are more mistakes of the discriminator 301 in discriminating).

As can be seen from the above expression, as the learning of the discriminator 301 progresses, the first term on the right side of the expression (1) becomes higher and the second term on the right side becomes lower. Meanwhile, as the learning of the generator 300 progresses, the first term on the right side of the expression (1) becomes lower and the second term on the right side becomes higher.

Next, learning by the second learner 211 will be described. In the example in FIG. 3, the second learner 211 calculates the first feature quantity from the second learning data using a learned model 400. The second learner 211 also calculates the second feature quantity from the second learning data using the learned model 400. Then, an error d between the first feature quantity and the second feature quantity is calculated and values of respective parameters constituting the generator 300 are learned such that this calculated error d is minimized. More specific content of learning by the second learner 211 will be described later.

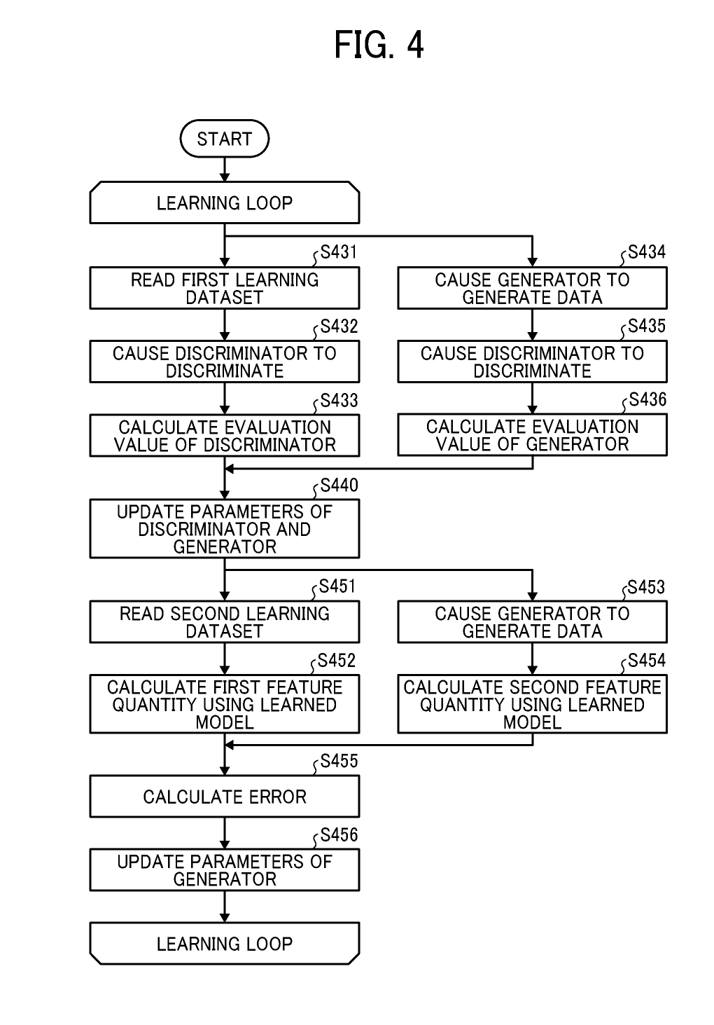

FIG. 4 is a flowchart illustrating an operation of learning the generative model performed by the learner 202 according to the embodiment. As described above, the learner 202 alternately repeats learning by the first learner 210 and learning by the second learner 202, such that the steps of FIG. 4 are repeated. The learner 202 repeats processes in steps S431 to S456 to learn the generative model. In the example in FIG. 4, the processes in steps S431 to S440 are learning by the first learner 210 and the processes in steps S451 to S456 are learning by the second learner 211.

First, the processes in steps S431 to S433 will be described. In step S431, the first learner 210 reads the first learning dataset prepared in advance from the dataset storage 201. Next, the first learner 210 causes the discriminator 301 to discriminate the first learning data (step S432) and calculates the evaluation value of the discriminator 301 depending on the result of the discrimination (step S433).

Next, the processes in steps S434 to S436 will be described. In step S434, the first learner 210 causes the generator 300 to generate data. Next, the first learner 210 causes the discriminator 301 to discriminate the data (generative data) generated in step S434 (step S435) and calculates the evaluation value of the generator 300 depending on the result of the discrimination (step S436).

After the processes in steps S431 to S433 and the processes in steps S434 to S436, the first learner 210 solves the evaluation function expressed by the above expression (1), thereby calculating (updating) values of parameters of each of the discriminator 301 and the generator 300 (step S440).

Subsequently, processes by the second learner 211 will be described. First, the processes in steps S451 and S452 will be described. In step S451, the second learner 211 reads the second learning dataset prepared in advance from the dataset storage 201. Next, the second learner 211 calculates the first feature quantity from the second learning data using the learned model 400 (step S452).

Next, the processes in steps S453 and S454 will be described. In step S453, the second learner 211 causes the generator 300 to generate data. Next, the second learner 211 calculates the second feature quantity from the data (generative data) generated in step S453 using the learned model (step S454).

After the processes in steps S451 and S452 and the processes in steps S453 and S454 described above, the second learner 211 calculates an error between the first feature quantity calculated in step S452 and the second feature quantity calculated in step S454 (step S455). Then, the parameter value of the generator 300 is calculated (updated) such that the error calculated in step S455 is minimized (step S456).

More specific content of learning by the second learner 211 will be described here. In the present embodiment, the above learned model refers to a model already learned by learning using the CNN which is an example of the deep learning and the second learner 211 regards the intermediate layer output and the style matrix used in A Neural Algorithm of Artistic Style which is an example of a style conversion technique using a neural network (hereinafter, when simply referred to as “style conversion technique”, this technique is indicated) as the feature quantity when learning. However, the learning by the second learner 211 is not limited to this configuration.

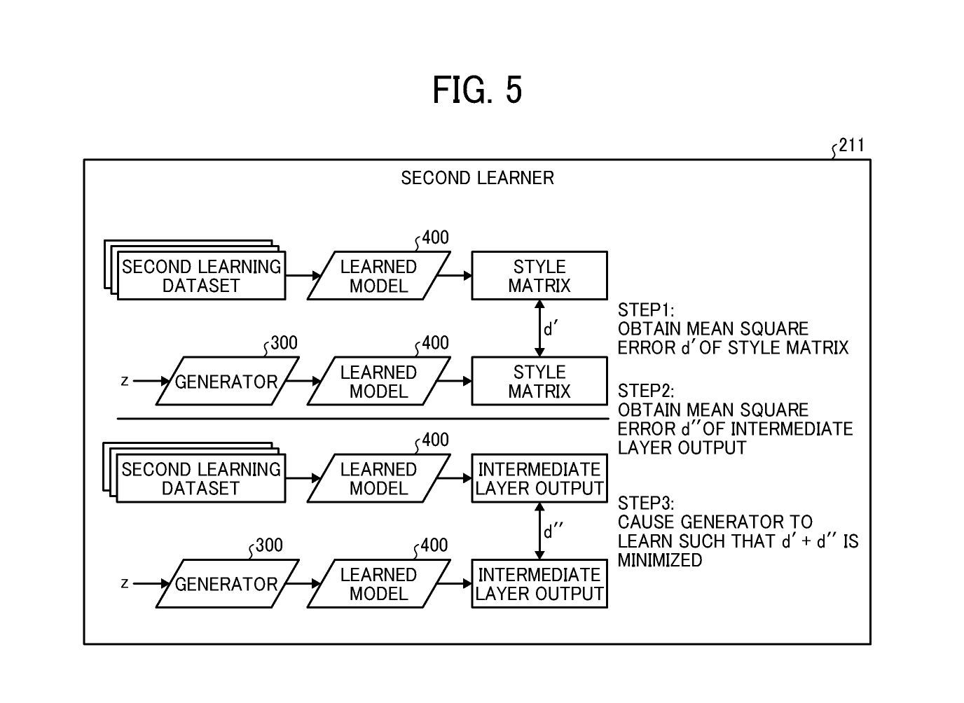

FIG. 5 is a diagram schematically illustrating a learning procedure by the second learner 211 in the present embodiment. In the present embodiment, the second learner 211 uses the learned model (a model already learned by learning using the CNN) to calculate the style matrix (an example of the aforementioned first feature quantity) from the second learning data. The second learner 211 also uses the above learned model to calculate the style matrix (an example of the aforementioned second feature quantity) from the data generated by the generator 300 (generative data). The style matrix can be obtained by calculating the Gram matrix using outputs from each filter of a plurality of layers (from an upper layer to a lower layer) corresponding to the hierarchy of the neural network. In the following description, the style matrix calculated from the second learning data is referred to as “first style matrix” and the style matrix calculated from the generative data is referred to as “second style matrix” in some cases. Then, the second learner 211 calculates the first style matrix for each of the plurality of pieces of the second learning data included in the second learning dataset and calculates errors between the calculated first style matrices and the second style matrices calculated from the generative data to obtain a mean square value of the errors (in the following description, sometimes referred to as “mean square error d′”).

In addition, the second learner 211 uses the above learned model to calculate the intermediate layer output (an example of the aforementioned first feature quantity) from the second learning data. The second learner 211 also uses the above learned model to calculate the intermediate layer output (an example of the aforementioned second feature quantity) from the data generated by the generator 300 (generative data). In this case, output values from each filter of the lower layer out of layers from the upper layer to the lower layer are used as the intermediate layer outputs. In the following description, the intermediate layer output calculated from the second learning data is referred to as “first intermediate layer output” and the intermediate layer output calculated from the generative data is referred to as “second intermediate layer output” in some cases. Then, the second learner 211 calculates the first intermediate layer output for each of the plurality of pieces of the second learning data included in the second learning dataset and calculates errors between the calculated first intermediate layer outputs and the second intermediate layer outputs calculated from the generative data to obtain a mean square value of the errors (in the following description, sometimes referred to as “mean square error d″”).

Subsequently, the second learner 211 learns values of respective parameters constituting the generator 300 such that the sum of the mean square error d′ and the mean square error d″ is minimized.

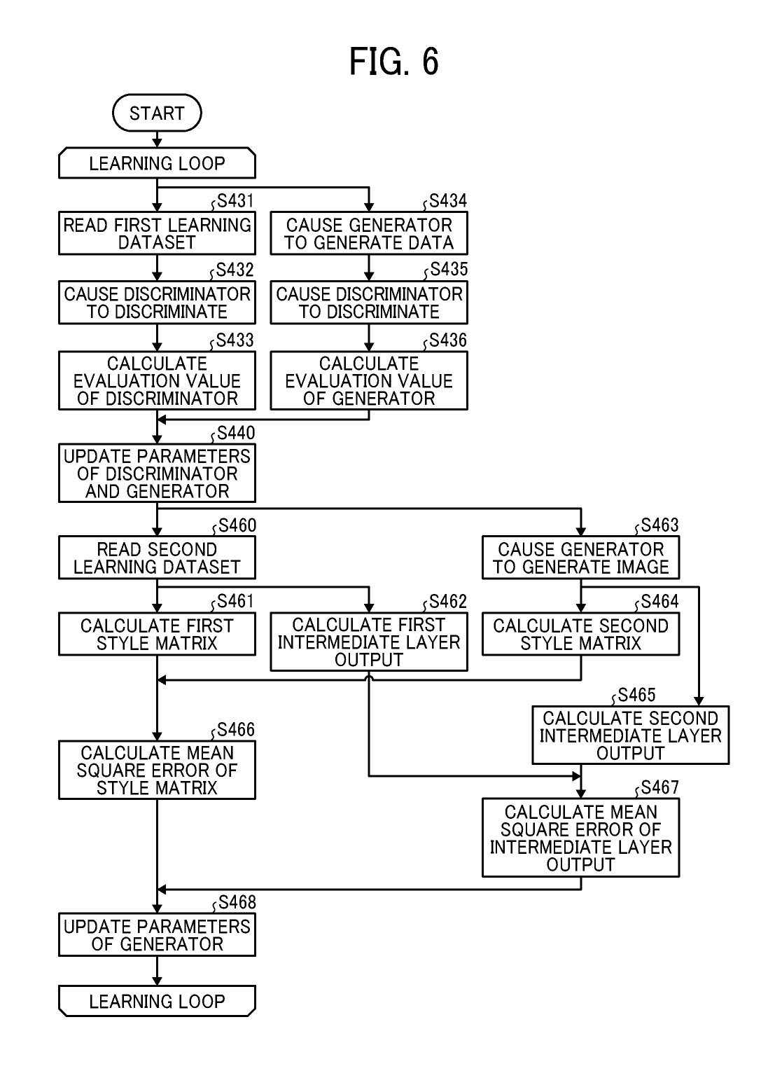

FIG. 6 is a flowchart illustrating an operation performed by the learner 202 according to the present embodiment. As described above, the learner 202 alternately repeats learning by the first learner 210 and learning by the second learner 202, such that the steps of FIG. 6 are repeated. In this flowchart, the processes by the second learner 211 (steps S460 to S468) are different from the processes in FIG. 4 but the other processes are the same. Hereinafter, the processes by the second learner 211 in the present embodiment (steps S460 to S468) will be described.

First, the processes in steps S460 to S462 will be described. In step S460, the second learner 211 reads the second learning dataset prepared in advance from the dataset storage 201. Next, the second learner 211 calculates the first style matrix from the second learning data using the learned model (step S461). Specifically, the first style matrix is calculated for each second learning data. The second learner 211 also calculates the first intermediate layer output from the second learning data using the learned model (step S462). Specifically, the first intermediate layer output is calculated for each second learning data.

Next, the processes in steps S463 to S465 will be described. In step S463, the second learner 211 causes the generator 300 to generate data. Next, the second learner 211 calculates the second style matrix from the data (generative data) generated in step S463 using the learned model (step S464). In addition, the second learner 211 calculates the second intermediate layer output from the data (generative data) generated in step S463 using the learned model (step S465). The order of the processes in steps S463 to S465 and steps S460 to S462 described above can be arbitrarily changed.

After the processes in steps S460 to S462 and the processes in steps S463 to S465 described above, the second learner 211 calculates errors between the first style matrices calculated in step S461 and the second style matrices calculated in step S464 for each of those first style matrices and calculates the mean square error d′ which is a mean square value of the errors (step S466). The second learner 211 also calculates errors between the first intermediate layer outputs calculated in step S462 and the second intermediate layer outputs calculated in step S465 for each of those first intermediate layer outputs and calculates the mean square error d″ which is a mean square value of the errors (step S467).

After step S466 and step S467 described above, the second learner 211 calculates (updates) values of respective parameters constituting the generator 300 such that the sum of the mean square error d′ and the mean square error d″ is minimized (step S468).

Here, a case where THE MNIST DATABASE of handwritten digits is used as a specific example of the learning data is assumed. In this case, 500 sheets are randomly selected from each of the classes “7” and “8” to be assigned as the first learning dataset and 500 images not used for the first learning dataset are selected from each of the classes to be assigned as the second learning dataset. When the learning dataset is selected in this manner, an image in which “7” and “8” are mixed is generated in normal learning according to the generative model. In the present embodiment, however, since information is given such that the second learning dataset has image structures of “7” and “8” as described above, it is confirmed that an image in which “7” and “8” are mixed is unlikely to be generated as a finally generated image.

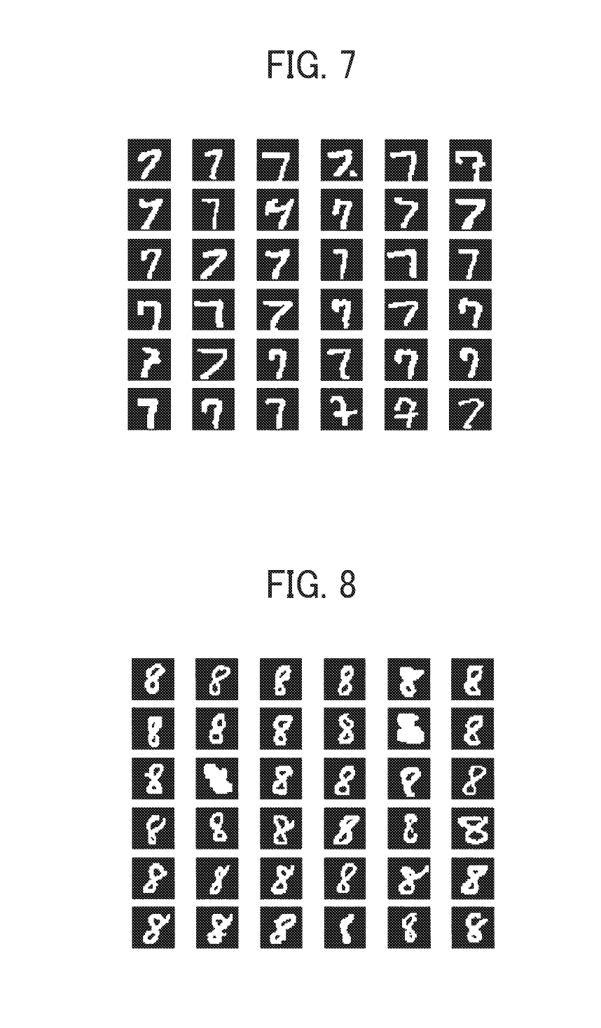

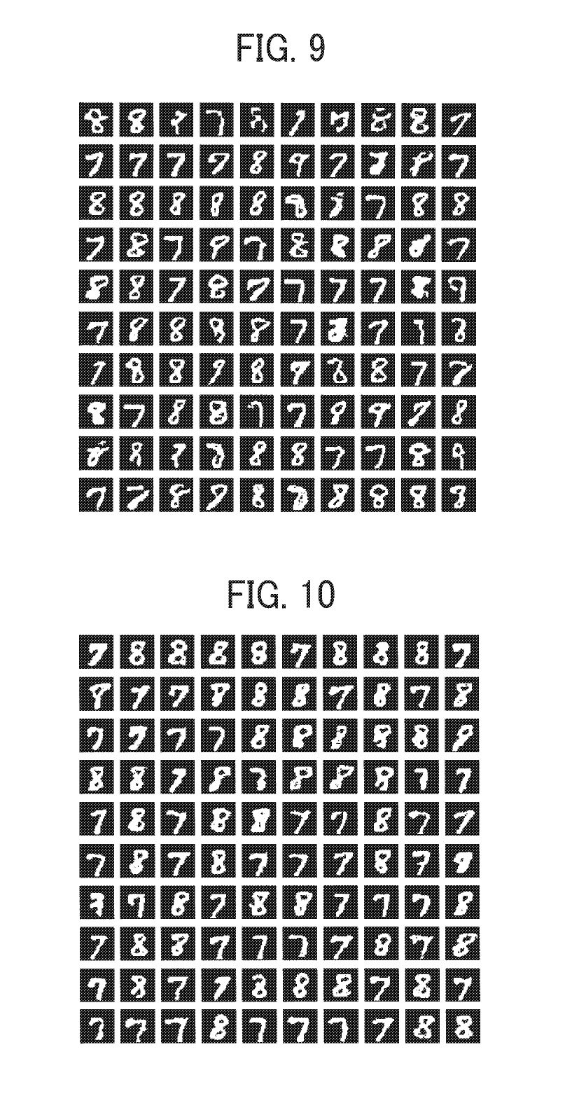

FIG. 7 is a diagram illustrating an example of images of the class “7” of MNIST used for learning and FIG. 8 is a diagram illustrating an example of images of the class “8” of MNIST used for learning. Meanwhile, FIG. 9 is a diagram illustrating an example of images generated using a conventionally known deep convolutional generative adversarial network (DCGAN) and FIG. 10 is a diagram illustrating an example of images generated according to the arrangement of the present embodiment. In the images illustrated in FIG. 9, an image looking like the numeral “9” which is not included in the images used for learning is generated and many unnatural images such as partially missing are generated. In contrast to this, in the images generated according to the arrangement of the present embodiment, it can be seen that almost no image looking like the numeral “9” is generated and most images have natural image structures.

As described above, in the present embodiment, learning by the above-described first learner 210 and learning by the above-described second learner 211 are alternately repeated to learn the generative model, whereby finally intended data can be generated. That is, the generative model is learned using different sets of the learning data and thus, it is possible to control the features of the data generated by the generative model. As a result, the data generated according to the finally learned generative model can be obtained as data intended by the user.

Additionally, the program executed by the generative model learning device 1 of the above-described embodiment may be arranged so as to be provided by being recorded in a computer-readable recording medium such as a compact disk read only memory (CD-ROM), a flexible disk (FD), a compact disk recordable (CD-R), a digital versatile disk (DVD), and a universal serial bus (USB) as a file in an installable format or executable format, or may be arranged so as to be provided or distributed by way of a network such as the Internet. Furthermore, various programs may be arranged so as to be provided by being incorporated in a ROM or the like in advance.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A generative model learning method comprising:
first learning a generative model for generating data based on first learning data; and
second learning the generative model being learned in the step of first learning based on second learning data, wherein
the step of first learning and the step of second learning are repeated.

2. The generative model learning method according to claim 1, wherein the step of first learning includes
learning the generative model according to a learning method by an adversarial network, the network including a generator to generate data and a discriminator to discriminate the first learning data and data generated by the generator.

3. The generative model learning method according to claim 2, wherein the step of first learning includes
learning the generative model based on an evaluation value of the generator and an evaluation value of the discriminator.

4. The generative model learning method according to claim 3, wherein
the evaluation value of the discriminator has a higher value as discrimination accuracy of the discriminator is higher, and
the evaluation value of the generator has a higher value as the discriminator erroneously recognizes data generated by the generator as being the first learning data more frequently.

5. The generative model learning method according to claim 1, wherein the step of second learning includes:
calculating a first feature quantity from the second learning data using a learned model used for calculating a feature quantity from input data;
calculating a second feature quantity from data generated according to the generative model, using the learned model; and
learning the generative model such that an error between the first feature quantity and the second feature quantity is minimized.

6. The generative model learning method according to claim 5, wherein
the learned model is a model already learned by deep learning.

7. The generative model learning method according to claim 6, wherein
the deep learning is learning using a convolutional neural network (CNN).

8. The generative model learning method according to claim 7, wherein the step of second learning includes:
calculating a first error indicating an error between a style matrix calculated from the second learning data using the learned model, and a style matrix calculated from data generated according to the generative model using the learned model;
calculating a second error indicating an error between an intermediate layer output calculated from the second learning data using the learned model, and an intermediate layer output calculated from data generated according to the generative model using the learned model; and
learning the generative model such that a sum of the first error and the second error is minimized.

9. The generative model learning method according to claim 8, wherein
the first feature quantity is a style matrix calculated from the second learning data using the learned model, and an intermediate layer output calculated from the second learning data using the learned model, and
the second feature quantity is a style matrix calculated from data generated according to the generative model using the learned model, and an intermediate layer output calculated from data generated according to the generative model using the learned model.

10. A system for learning generative model comprising:
one or more processors; and
one or more non-transitory computer-readable media storing instructions which, when executed by the one or more processors, cause the processors to cause:
first learning a generative model for generating data based on first learning data; and
second learning the generative model being learned in the step of first learning based on second learning data, wherein
the step of first learning and the step of second learning are repeated.

11. A non-transitory recording medium which, when executed by one or more processors, cause the processors to perform a generative model learning method comprising:
first learning a generative model for generating data based on first learning data; and
second learning the generative model being learned in the step of first learning based on second learning data, wherein
the step of first learning and the step of second learning are repeated.
